(19) United States
(12) Patent Application Publication
(10) Pub. No.: US 2009/0096236 A1
(43) Pub. Date: Apr. 16, 2009

(54) TRUCK BED RACK

(76) Inventor: Ronald Hawley, Winona, MN (US)

Correspondence Address: Altera Law Group, LLC, 220 S 6 St Suite 1700, Minneapolis, MN, 55402, US

(21) Appl. No.: 12/212,895

(22) Filed: Sep. 18, 2008

Related U.S. Application Data
(60) Provisional application No. 60/974,308, filed on Sep. 21, 2007.

(51) Int. Cl. B60P 3/40; A47F 7/00

(52) U.S. Cl. 296/3; 211/70.6

(57) ABSTRACT

The present invention comprises various embodiments of a rack that is adapted for the bed of a pickup truck for securing ramps, ladders and the like. The rack comprises two spaced apart vertical support members. Each vertical support member comprises two spaced apart U-support assemblies. Each of the resulting four U-support assemblies are independently and slidably adjustable relative to the other U-support assemblies. In the preferred embodiment, the slidable adjustment capabilities of the U-support assemblies comprises infinite adjustability. Thus, the present invention allows for securing ramps, ladders and the like having varying widths.

### RELATED APPLICATION DATA

This application claims priority to U.S. provisional patent application No. 60/974,308, filed Sep. 21, 2007.

### BACKGROUND OF THE INVENTION

1. Field of the Invention

The present invention is directed to a rack device adapted for a truck bed.

2. Description of the Related Art

### BRIEF SUMMARY OF THE INVENTION

The present invention comprises various embodiments of a rack that is adapted for the bed of a pickup truck for securing ramps, ladders and the like. The rack comprises two spaced apart vertical support members. Each vertical support member comprises two spaced apart U-support assemblies. Each of the resulting four U-support assemblies are independently and slidably adjustable relative to the other U-support assemblies. In the preferred embodiment, the slidable adjustment capabilities of the U-support assemblies comprises infinite adjustability. Thus, the present invention allows for securing ramps, ladders and the like having varying widths.

An object of the present invention provides a rack adapted for the bed of a pickup truck.

Another object of the present invention provides a rack adapted for the bed of a pickup truck and for securing a ramp or ladder of various lengths, width and/or having varying widths.

Another object of the present invention provides a rack adapted for the bed of a pickup truck and for securing a ramp or ladder of various widths and/or having varying widths, the rack comprising two vertical support members, each vertical support member comprising two U-support assemblies, the four U-support assemblies being independently and infinitely slidably vertically adjustable along the relevant vertical support members.

The figures and the detailed description which follow more particularly exemplify these and other embodiments of the invention.

### BRIEF DESCRIPTION OF THE DRAWINGS

The invention may be more completely understood in consideration of the following detailed description of various embodiments of the invention in connection with the accompanying drawings, which are as follows.

FIG. 1 is a perspective view of one embodiment of the present invention.

FIG. 2A is a perspective partial cutaway view of one embodiment of one element of the present invention.

FIG. 2B is a perspective partial cutaway view of one embodiment of one element of the present invention.

FIG. 3A is a perspective view of one embodiment of one element of the present invention

FIG. 3B is a perspective view of one embodiment of one element of the present invention

FIG. 4 is perspective view of one embodiment of the present invention.

FIG. 5A is a perspective view of one embodiment of one element of the present invention.

FIG. 5B is a side view of one embodiment of one element of the present invention.

FIG. 6A is a top perspective view of one embodiment of one element of the present invention.

FIG. 6B is a bottom perspective view of one embodiment of one element of the present invention

FIG. 7 is a perspective view of one embodiment of the present invention.

### DETAILED DESCRIPTION OF THE INVENTION, INCLUDING THE BEST MODE

While the invention is amenable to various modifications and alternative forms, specifics thereof are shown by way of example in the drawings and described in detail herein. It should be understood, however, that the intention is not to limit the invention to the particular embodiments described. On the contrary, the intention is to cover all modifications, equivalents, and alternatives falling within the spirit and scope of the invention.

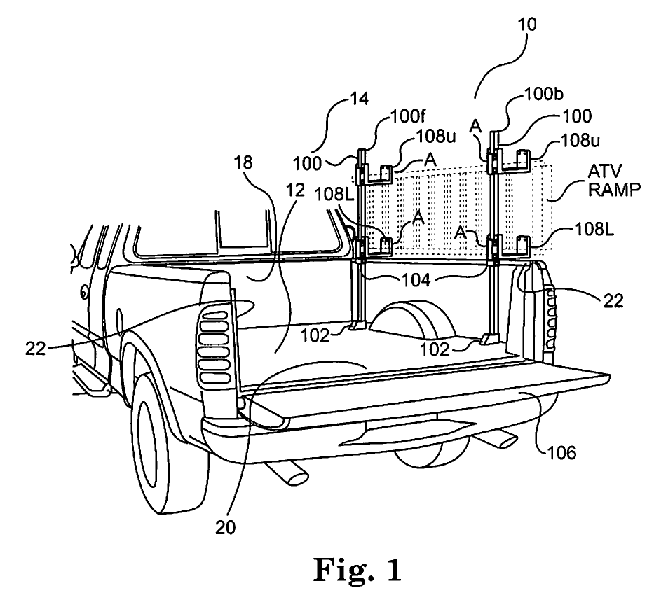

With reference to the figures, the present invention generally comprises a rack 10 adapted for the bed 12 of a pickup truck 14. A pickup truck bed 12 commonly comprises a floor 16 defined by a front side 18, a back side 20 and a pair of opposing side walls 22 therebetween. The rack 10 comprises two vertical support members 100f, 100b, each vertical support member 100f, 100b being operationally received within a rack holder 102 that is attached to the bed floor 16 and at least one of the side walls 22 of the pickup truck bed 12 by a vertical support member clamp 104. Preferably, the two vertical support members 100f, 100b are spaced apart so as to comprise a front vertical support member 100f that is proximal to the bed's front side 18, and a back vertical support member 100b that is proximal to the bed's back side 20 which may further comprise the truck's tailgate 106 which, when in the upright and closed position further defines the truck bed 12. Two U-support assemblies A, comprising an upper U-support member 108U and lower support member 108L are slidably adjustably mounted, preferably spaced apart, to each of the vertical support members 100f, 100b for securing a ladder and/or all-terrain vehicle (ATV) ramp or the like as is shown in phantom in FIG. 1.

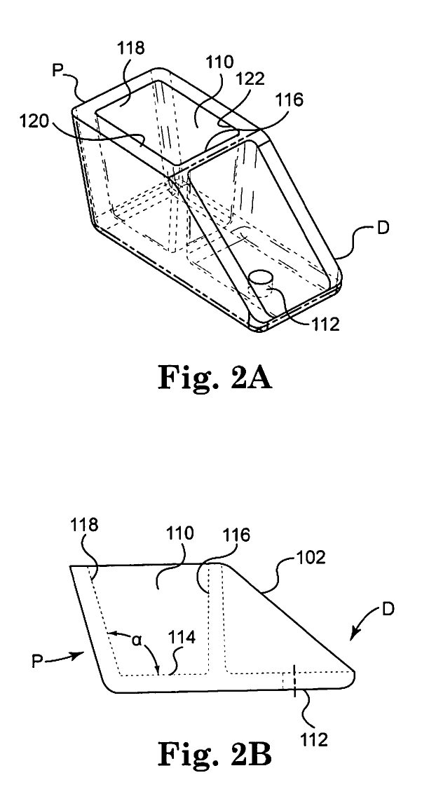

Each vertical support member 100f, 100b of the rack 10 is stabilized in part and fixed to the truck's bed floor by its operational engagement with the rack holder 102. As is best illustrated in FIGS. 2A and 2B, the rack holder 102 comprises a proximal end P and a distal end D and a stake pocket 110 proximate the proximal end P which receives one of the vertical support members 100f, 100b therein.

The rack holder 102 further comprises an aperture 112 therethrough which is proximate the distal end D which allows operational, e.g., bolting, securement to the truck bed 12 as will be readily understood by the skilled artisan. This aperture 112 is preferably oriented upon installation facing away from the side wall 22 against which the rack holder 102 is to be secured as will be discussed further below. The preferred installation of the illustrated embodiment comprises the proximal end P of the rack holder 102 being in proximity with the side wall 22 of the truck bed 12 against which the rack 10 will ultimately be secured.

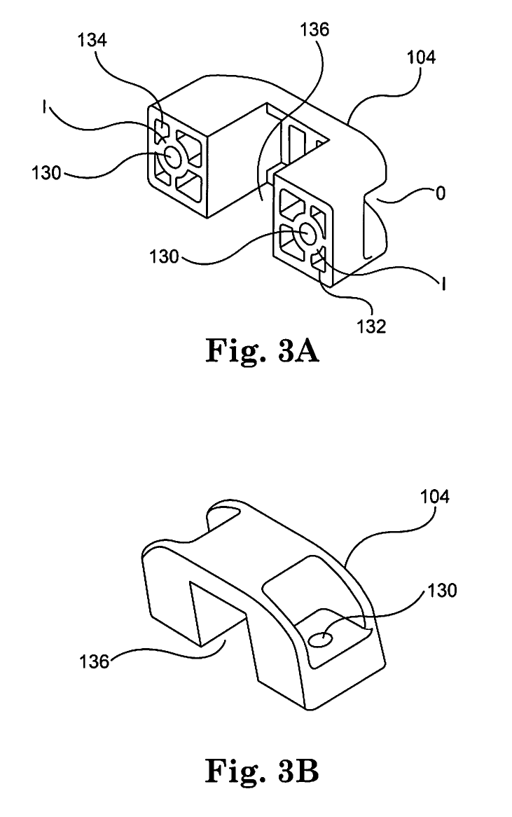

The stake pocket 110 as illustrated is defined by a stake pocket floor 114 with a profile that is complementary with the cross-sectional profile of the vertical support member 100f, 100b, and four stake pocket walls, a front stake pocket wall 116, a back stake pocket wall 118 and right 120 and left 122 stake pocket walls therebetween. As shown in FIG. 3, the back stake pocket wall 118 preferably comprises an obtuse angle α, preferably 105 degrees but other angles—including 90 degrees—with respect to the stake pocket floor 114 represent alternate embodiments that are within the scope of the present invention. The front 116, right 120 and left 122 stake pocket walls each comprise approximately 90 degree angles with respect to the stake pocket floor 114. When the rack holder is installed, this preferably obtuse angle α allows translational adjustment of the vertical support member 108f, 108b received within the stake pocket 110 in order to better facilitate fixed operational attachment and adjustability of position of the vertical support member 100f, 100b to the truck bed side wall 22.

As illustrated in the Figures, the vertical support members 100f, 100b each comprise a square cross-sectional profile, though other profiles are certainly within the scope of the present invention. The corresponding cross-sectional profile of the stake pocket 110 at its floor 114 is complementary to the cross-sectional profile of the corresponding vertical support member 100f, 100b. Thus, the vertical support member 100f, 100b and stake pocket 110 comprise substantially square cross-sectional profiles, allowing operational engagement and reception of the vertical support member 100f, 100b within the stake pocket 110. This arrangement ensures rotational stabilization of the vertical support member 100f, 100b when it is received within the stake pocket 110, preventing the vertical support member 100f, 100b from rotational motion within the stake pocket 110. At the same time, the obtuse angle α of the back stake pocket wall 118 allows the vertical member 100f, 100b to be slightly adjusted laterally to facilitate fixed and operational engagement with the truck bed side wall 22. Moreover, the vertical support member 100f, 100b may simply be slid out of the stake pocket 110 when desired.

Once the vertical support member 100f, 100b is received within the stake pocket 110, the upper portion of the vertical support member 100f, 100b may then be laterally translated to a point at which it rests in operative engagement against the side wall 22 of the truck bed 12. The vertical support member clamp 104 is then used to fixedly attach the vertical support member 100f, 100b to the bed's side wall by apertures 130 by any well-known means, including, e.g., bolting. The vertical support member clamp 104 further comprises an inner surface I and an outer surface O. The inner surface I comprises a right 132 and left side 134 which pressingly engage the bed's side wall 22 when the vertical support member clamp 104 is fixed against the side wall 22. A vertical support member channel 136 is disposed between the right 132 and left 134 sides of the inner surface I. This channel 136 is preferably comprises a profile that is complementary with the cross-sectional profile of the vertical support member to facilitate receiving at least part of the vertical support member 100 therein so as to ensure a snug fit when the vertical support member clamp 104 operationally engages the vertical support member 100 as illustrated in the Figures. This engagement secures the vertical support member 100 against the side wall 22 and, in combination with the stake pocket 100, prevents any rotational motion as well as any lateral or translational movement; the vertical support member 100 is thus fixed in place. As discussed above, the vertical support member 100 is illustrated as a substantially square cross-sectional profile embodiment, thus the vertical support member channel 136 is also substantially square to ensure a snug fit when engaging and receiving at least part of the vertical support member 100. However, the skilled artisan will recognize that a variety of cross-sectional profiles for the vertical support member 100 and vertical support member channel 136 exist; so long as there is an operational engagement between the vertical support member 100 and channel 136 as described herein, each such combination is within the scope of the present invention.

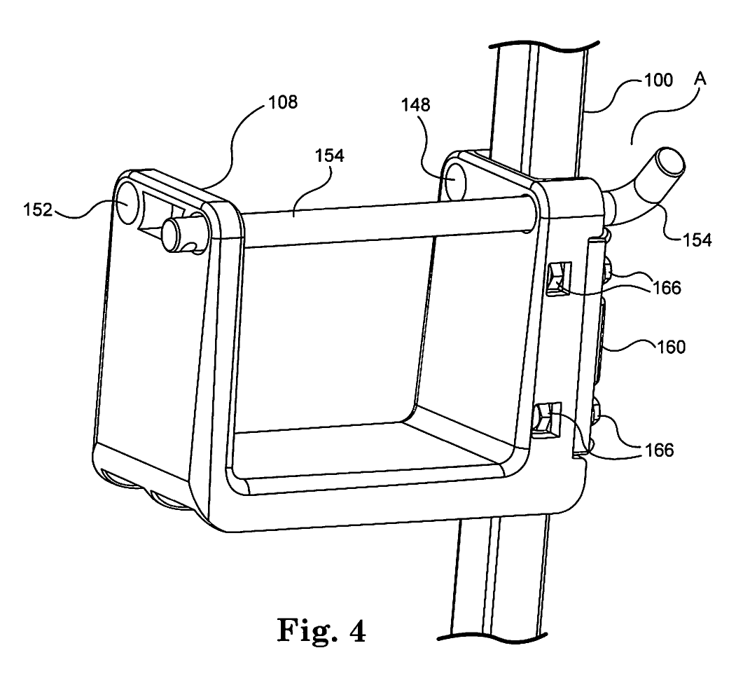

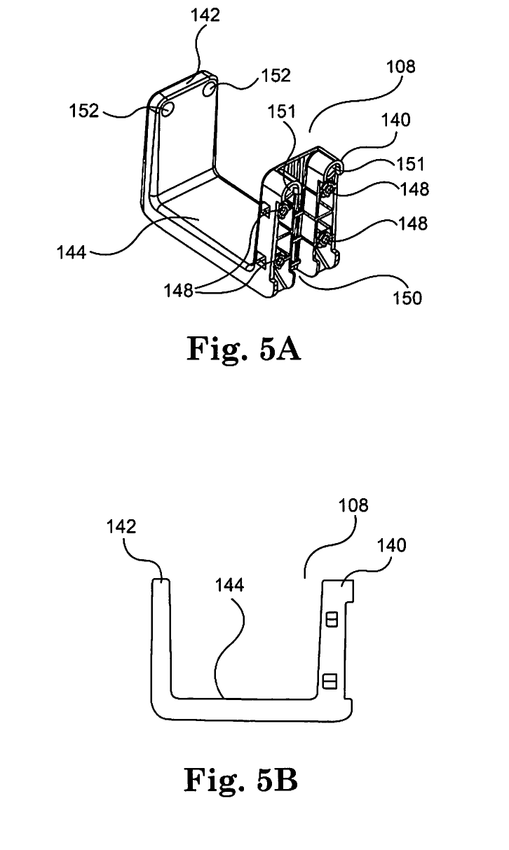

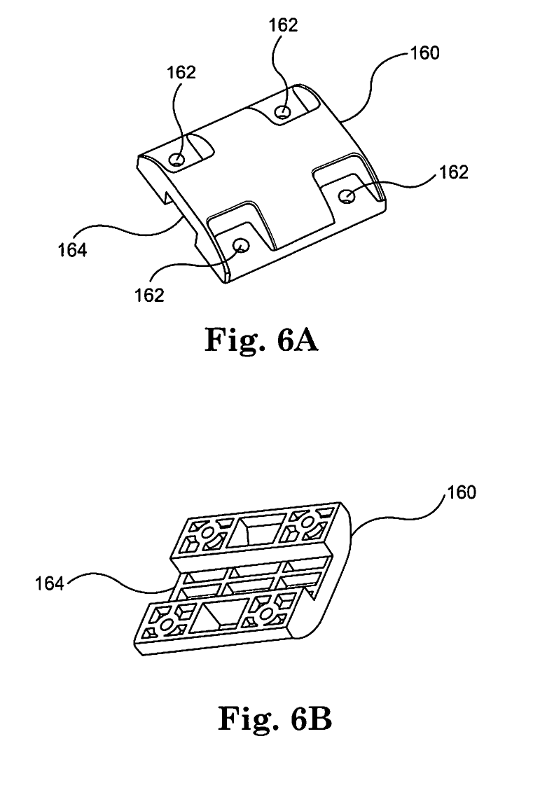

As is best illustrated in FIGS. 4, 5A and 5B, the front and back vertical support members 100f, 100b each comprise operational and slidably adjustable engagement with two U-support assemblies A, each comprising a U-support member 108 and U-support member clamp 160. Thus, each vertical support member 100f, 100b comprises an operational and slidably adjustable engagement with an upper U-support member 108U and a lower U-support member 108L for a total of four U-support members 108 in the preferred embodiment.

Each U-support member 108 comprises a bracket side 140, a locking side 142 and a rack support member 144 therebetween. The bracket side 140 comprises a vertical support member channel 150 defined on its inner portion with a profile complementary to that of the vertical support member 100 and for operationally engaging and receiving at least part of the vertical support member 100 therein. As shown, the rack support member 144 defines a 90 degree angle with both the bracket side 140 and the locking side 142. Other embodiments may comprise these angles being 90 degrees, acute and/or obtuse. One alternative embodiment may comprise, e.g., an acute angle of 85 degrees between the rack support member 144 and the bracket side 140, creating a slight incline in the rack support member 144.

The bracket side 140 further comprises four apertures therethrough 148 for operational engagement with U-support member clamp 160 and further defines a vertical support member channel 150. The vertical support member channel comprises a cross-sectional profile that is preferably complementary with the cross-sectional profile of vertical support member 100 to facilitate operational engagement with the vertical support member 100 as it is received at least partially within channel 150. Bracket side 140 further comprises two locking pin apertures 151 and locking side comprises two locking pin apertures 152. As is best shown in FIG. 4, locking pin apertures 151 and 152 are substantially aligned to allow insertion of a locking pin 154 through one or both of the aligned pairs of apertures 151, 152.

Once the vertical support member 100 is operationally engaged with U-support member 108, i.e., received at least partially within channel 150, the U-support member clamp 160 is operationally secured to the apertures 148 by known means. U-support member clamp 160 defines a vertical support channel 164 as well as four apertures 162. The vertical support channel 164 aligns with and receives at least partially the vertical support member 100 and the four apertures 162 then substantially align with the U-support member apertures 148. Operational engagement is achieved by adjustably fixing the U-support member to the U-support member clamp by known fixation means 166, e.g., a nut and bolt assembly, as is indicated in FIG. 4.

At this stage of the operation, each U-support assembly A may be slidingly moved along the vertical support member 100 until the proper height is located, then the fixation means 166 may be tightened to fix the U-support assembly A tightly against the vertical support member 100, thus fixing its location thereon. Each of the remaining U-support assemblies A may then be similarly adjusted and fixed. The ladder or ramp may then be placed and securingly supported on the rack as shown in FIG. 1. Locking pin inserted through apertures 148 and 152 completes the process of securing the ladder or ramp.

Thus, the present invention provides an embodiment which allows for sliding and infinite adjustability of the U-support assemblies A along the vertical support member 100. This, in turn, provides a device which may accommodate ladders or ramps of various continuous or varying widths since each of the U-support assemblies are independently adjustable relative to each other.

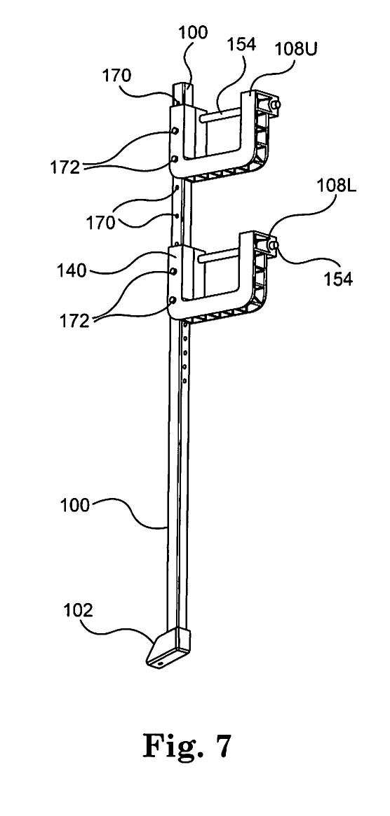

An alternate embodiment of the present invention comprising finite adjustability of the U-support assemblies is shown in FIG. 7. In this embodiment, the vertical support member 100 may comprise a plurality of adjustability apertures 170 at least partially therethrough. In these embodiments, the bracket side 140 of the U-support members 108U, 108L may comprise a vertical member channel (not shown) therealong as described above and at least one, preferably two, apertures 172 which allow secured, but adjustable, attachment to the U-support member adjustability apertures 170 which are arranged at predetermined distances from each other. When apertures 170 are aligned with apertures 172, fixation means such as bolts may be used to secure the U-support member at the desired location along the vertical support member 100. This arrangement, as the skilled artisan will readily recognize, provides a level of height adjustability of each of the U-support assemblies comprising U-support members 108U, 108L along the vertical support member 100 relative to the truck bed floor and relative to each other. In this manner, ramps and/or ladders of varied widths may be accommodated.

The various components of the present invention, i.e., the stake pocket, vertical support member, vertical support member clamp, and U-support member may be comprised of a high strength and low weight material such as aluminum, steel and/or reinforced molded plastic and the like.

The present invention should not be considered limited to the particular examples described above, but rather should be understood to cover all aspects of the invention. Various modifications, equivalent processes, as well as numerous structures to which the present invention may be applicable will be readily apparent to those of skill in the art to which the present invention is directed upon review of the present specification.

What is claimed is:

1. A rack adapted for a pickup truck bed, the bed comprising a floor defined by a front side, a back side and a pair of opposing walls, the rack comprising:
two rack holders spaced apart and in fixedly attached to the floor of the bed, the rack holder comprising an aperture to facilitate the fixed attachment to the floor of the bed and a stake pocket, the stake pocket having a cross-sectional profile;
two vertical support members having a cross-sectional profile that is complementary with the cross-sectional profile of the stake pocket, each vertical support member operationally engaged within one of the stake pockets;
a vertical support member clamp for each of the two vertical support members, the vertical support member clamp attaching the vertical support member to one of the opposing walls of the truck bed; and
an upper U-support assembly and a lower U-support assembly operationally engaged with each vertical support member, each of the U-support assemblies being independently slidably adjustable along the vertical support member.

2. The rack of claim 1, the stake pocket further comprising a stake pocket floor, a front stake pocket wall, a back stake pocket wall, a right stake pocket wall and a left stake pocket wall, wherein the back stake pocket wall and stake pocket floor form an obtuse angle therebetween.

3. The rack of claim 2, wherein the upper and lower U-support assemblies further comprise:
a U-support member in operational engagement with the vertical support member; and
a U-support member clamp in operational engagement with the vertical support member and the U-support member.

4. The rack of claim 3, wherein the U-support member further comprises a bracket side, a locking side and a rack support member therebetween.

5. The rack of claim 4, wherein the bracket side further comprises:
a vertical support member channel having a cross-sectional profile that is complementary with the cross-sectional profile of the vertical support member and receives at least part of the vertical support member therein; and
four apertures therethrough.

6. The rack of claim 5, wherein the U-support member clamp further comprises a vertical support member channel having a cross-sectional profile that is complementary with the cross-sectional profile of the vertical support member and receives at least part of the vertical support member therein;
four apertures therethrough that are substantially aligned with the four apertures of the bracket side of the U-support member; and
adjustable fixation means operationally engaging the four apertures of the U-support member clamp with the four aligning apertures of the U-support member.

7. The rack of claim 6, further comprising the U-support member clamp, vertical support member and U-support member in slidably adjustable operational engagement.

8. The rack of claim 1, wherein the U-support assemblies are independently and infinitely slidably adjustable along the vertical support members.

9. The rack of claim 1, wherein the U-support assemblies comprise reinforced molded plastic.

10. A rack adapted for a pickup truck bed, the bed comprising a floor defined by a front side, a back side and a pair of opposing walls, the rack comprising:
two rack holders spaced apart and in fixedly attached to the floor of the bed, the rack holder comprising an aperture to facilitate the fixed attachment to the floor of the bed and a stake pocket, the stake pocket having a cross-sectional profile and further comprising a stake pocket floor, a front stake pocket wall, a back stake pocket wall, a right stake pocket wall and a left stake pocket wall, wherein the back stake pocket wall and stake pocket floor form an obtuse angle therebetween;
two vertical support members having a cross-sectional profile that is complementary with the cross-sectional profile of the stake pocket, each vertical support member operationally engaged within one of the stake pockets;
a vertical support member clamp for each of the two vertical support members, the vertical support member clamp attaching the vertical support member to one of the opposing walls of the truck bed;
an upper U-support member and a lower U-support member operationally engaged with each vertical support member, each U-support member comprising:
a bracket side, a locking side and a rack support member therebetween, the bracket side further comprising a vertical support member channel having a cross-sectional profile that is complementary with the cross-sectional profile of the vertical support member and receives at least part of the vertical support member therein; and
four apertures therethrough; and
a U-support member clamp comprising:
a vertical support member channel having a cross-sectional profile that is complementary with the cross-sectional profile of the vertical support member and receives at least part of the vertical support member therein;
four apertures therethrough that are substantially aligned with the four apertures of the bracket side of the U-support member; and
adjustable fixation means operationally engaging the four apertures of the U-support member clamp with the four aligning apertures of the U-support member.

11. A rack adapted for a pickup truck bed, the bed comprising a floor defined by a front side, a back side and a pair of opposing walls, the rack comprising:
two rack holders spaced apart and in fixedly attached to the floor of the bed, the rack holder comprising an aperture to facilitate the fixed attachment to the floor of the bed and a stake pocket, the stake pocket having a cross-sectional profile;
two vertical support members having a cross-sectional profile that is complementary with the cross-sectional profile of the stake pocket and a plurality of adjustability apertures at least partially therethrough, wherein each vertical support member is operationally engaged within one of the stake pockets;
a vertical support member clamp for each of the two vertical support members, the vertical support member clamp attaching the vertical support member to one of the opposing walls of the truck bed;
an upper U-support member and a lower U-support member adjustably attached to each of the vertical support members, each U-support member comprising a bracket side defining a vertical support member channel therealong and at least one aperture therethrough, the at least one aperture substantially aligning with at least one of the plurality of adjustability apertures of the vertical support member; and
fixation means to secure the U-support members to the vertical support member.

12. The rack of claim 11, wherein the U-support members comprise reinforced molded plastic.
